(19) United States
(12) Patent Application Publication
(10) Pub. No.: US 2004/0189133 A1
(43) Pub. Date: Sep. 30, 2004

(54) Method for insulation of stator windings

(76) Inventors: Thomas Baumann, Wettingen (CH); Albrecht Bock, Viernheim (DE); Joerg Oesterheld, Birmenstorf (CH)

Correspondence Address: CERMAK & KENEALY LLP, P.O. BOX 7518, ALEXANDRIA, VA, 22307, US

(21) Appl. No.: 10/760,303

(22) Filed: Jan. 21, 2004

(30) Foreign Application Priority Data
Jul. 22, 2002 (WO) PCT/IB02/02853
Jul. 21, 2001 (DE) 101 35 718.4

(51) Int. Cl. H02K 15/12; H02K 3/04

(52) U.S. Cl. 310/215; 310/201; 310/45; 29/734

(57) ABSTRACT

The invention relates to a method for application of the main insulation to conductor bars, in particular conductor bars for stator windings, with the conductor bars having a rectangular cross section. The method comprises the following steps: connection of the individual conductor bars to form a quasi-infinite conductor bar with a rectangular cross section; sheathing of the quasi-infinite, rectangular conductor bar with main insulation; cutting out or detaching of the unusable connecting points.

### TECHNICAL FIELD

The invention relates to a method for insulation of stator windings for rotating electrical machines, in particular for DC machines and AC machines.

### PRIOR ART

In general, electrical machines such as these have a stator and a rotor, in order to convert mechanical energy to electrical energy (generator) or in order, conversely, to convert electrical energy to mechanical energy (electric motor). Depending on the operating mode of the electrical machine, voltages are produced in the conductors of the stator windings. The conductors of the stator windings must therefore be appropriately insulated in order to avoid short circuits.

Stator windings in electrical machines may be designed differently. It is possible to group two or more individual conductors which are insulated from one another and to provide the conductor group produced in this way, which is often referred to as a conductor bar, with so-called main insulation. Two or more conductor bars are connected to one another at their end surfaces in order to produce the stator windings. This connection may be made, for example, via a metal plate, to which both the respectively insulated individual conductors in the first conductor bar and the respectively insulated individual conductors in the second conductor bar are conductively connected. The individual conductors in the conductor bar are therefore not insulated from one another in the area of the metal plate.

As an alternative to forming groups of individual conductors to form conductor bars, a long, insulated individual conductor is wound to form a planar, oval coil, which is referred to as a coil template or fish. In a subsequent process, so-called spreading, the coil templates or fish are changed to their final shape and are installed in the stator.

Both round and rectangular individual conductors may be used in both of the manufacturing techniques described above. The conductor bars or coil templates which are manufactured from two or more individual conductors for the stator windings may in turn each have a round or a rectangular cross section. In the present invention, conductor bars or coil templates with rectangular cross section, and which have been manufactured from rectangular individual conductors, are preferably considered. The conductor bars may not only be transposed, that is to say individual conductors which are twisted with respect to one another, but may also be non-transposed, that is to say individual conductors which run parallel to one another and are not twisted.

According to the prior art, mica paper, which is reinforced by a glass fiber mount for mechanical reasons, and is in the form of a strip, is generally wound around the conductor in order to provide insulation for the stator windings (for example conductor bars, coil templates, coils). The wound conductor, which may also possibly be shaped after the winding process, is then impregnated by means of a curing resin, which leads to thermosetting plastic insulation which cannot melt. Furthermore, insulation containing mica and with a thermoplastic matrix is known, which is likewise applied to the conductor in strip form, such as asphalt, shellac (Brown Boveri Review Vol. 57, page 15: R. Schuler; “Insulation Systems for High-Voltage Rotating Machines”) polysulfone and polyetherether ketone (DE 43 44044 A1).

Insulation such as this can be shaped plastically again above the melting temperature of the matrix.

This insulation, which is applied by winding around, for stator windings has the disadvantage that its manufacture is time-consuming and costly. In this context, the winding process and the impregnation process should be mentioned in particular, and these can no longer be speeded up significantly owing to the physical characteristics of the mica paper and of the impregnation resin. Furthermore, this manufacturing process is in fact susceptible to faults with thick insulation, if mica paper does not adequately match the stator winding. In particular, inaccurate adjustment of the winding machine after the mica paper has been wound around the stator winding can result in folds and cracks, for example as a result of the angle between the mica paper and the conductor being too steep or too flat, or as a result of an unsuitable static or dynamic tension force acting on the mica paper during the winding process. Furthermore, excessive strip application can result in excess pressure points, which prevent uniform impregnation throughout the insulation in the impregnation mold. Locally or generally faulty insulation may thus be produced, which has a reduced short-term and/or long-term strength. This considerably reduces the life of such insulation for stator windings.

Furthermore, production methods for sheathing conductor groups are known from cable technology, in which case conductor groups with a round cross section are always sheathed with a thermoplastic or with elastomers in an extrusion process. The document U.S. Pat. No. 5,650,031, which relates to the same subject matter as WO 97/11831, describes a method such as this for insulation of stator windings, in which the stator winding is passed through a central hole in an extruder. During the process, the stator winding, which has a complex shape, is simultaneously sheathed with an extruded thermoplastic material on every side of the complex shape, particularly by means of co-extrusion.

Furthermore, polymer insulation is known from cable technology, which is applied to the cables by means of a heat-shrinking technique. This insulation is in the form of a prefabricated flexible sleeve with a round cross section and composed of thermoplastics, elastomers, polyvinylidene fluoride, PVC, silicone elastomer or Teflon, which can be crosslinked. These materials are stretched and cooled in the heated state after fabrication. After cooling down, the material retains its stretched shape. This is done, for example, by forming crystalline centers which fix the stretched macromolecules. When they are heated up once again beyond the crystalline melting point, the crystalline zones become detached, with the macromolecules once again assuming their unstretched state, so that the insulation shrinks. Furthermore, cold shrinking flexible sleeves are known, which are widened mechanically in the cold state. These flexible sleeves are drawn over a supporting structure in the widened state, holding the flexible sleeves permanently in the stretched state. Once the flexible sleeves have been pushed over the components to be insulated and have been fixed, the supporting structure is removed in some suitable manner, for example by pulling out a supporting structure which is perforated in a spiral shape. However, shrinking techniques such as these cannot be used for stator windings with a rectangular cross section, since the flexible sleeves with a round cross section tear easily on the edges of the rectangular conductors, either immediately after being shrunk or after being loaded briefly during operation of the electrical machine, owing to the thermal and mechanical stress.

Even during production of the stator windings, particularly during bending of the conductors and during handling, and in particular during installation in the stator, the insulation has to withstand a particularly high mechanical stress, which can damage the insulation on the stator windings. Furthermore, the insulation on the stator winding conductors is subject to combined stresses during operation of the electrical machine. On the one hand, the insulation is dielectrically stressed by the resultant electrical field between the conductor which is at a high voltage and the stator. On the other hand, the insulation is subjected to alternating thermal stresses resulting from the heat produced in the conductor, with there being a high temperature gradient in the insulation when passing through the respective operating states of the machine. Alternating mechanical loads also occur owing to the different expansion of the materials involved. This on the one hand leads to a shear stress in the adhesive bonding between the conductor and the insulation while, on the other hand, there is a risk of abrasion at the boundary surface between the insulation and the stator slot wall. These high stresses can result in cracks being formed in the insulation on the stator windings, causing short circuits. This leads to failure of the entire electrical machine, with the repair being associated with a high time and cost penalty.

### DESCRIPTION OF THE INVENTION

This is the point of the invention. The invention, as it is described in the claims, is based on the object of providing a simple, cost-effective method for the insulation of stator windings for rotating electrical machines, with insulated stator windings being produced which ensure the insulation of the stator windings throughout the intended life of the electrical machine.

This object is achieved by a method for application of the main insulation to conductor bars, in particular conductor bars for stator windings, with the conductor bars having a rectangular cross section, and the method comprising the following steps:

a) connection of the individual conductor bars to form a quasi-infinite conductor bar with a rectangular cross section;

b) continuous sheathing of the quasi-infinite, rectangular conductor bar with main insulation;

c) cutting out or detaching of the unusable connecting points.

This results in a method for insulation of conductor bars which is considerably simpler and more cost-effective than the winding methods which are known from the prior art.

In step a, conductor bars which extend in straight lines are particularly advantageously used and the sheathing in step b is carried out with an elastomer, preferably with a silicone elastomer. The invention makes use of the high elasticity of the elastomer with its high thermal and electrical load capacity at the same time. In one advantageous refinement of the method, the quasi-infinite conductor which is formed in step a is sheathed with the elastomer in an extrusion process.

In another advantageous embodiment, the conductor is first of all manufactured as a stretched, quasi-infinite structure and is then sheathed, with step a being omitted.

As an alternative, the blow forming technique may be used for sheathing, in which a flexible sleeve is first of all extruded in order then to subsequently place it over the conductor.

In a further method according to the invention, internal corona-discharge protection is applied between the insulating layer and the conductor surface. This is done, for example, by means of double or triple co-extrusion, or advantageously by means of the blow forming technique, by means of which a large number of individual layers can be laid one on top of the other.

In one particularly preferred method, the conductor bars are not changed to their final shape until after they have been sheathed with the elastomer. Bending of the evolvent results in the applied insulation being greatly expanded. The use of elastomer according to the invention has in this case been found to be particularly advantageous, since it reduces or entirely prevents the mechanical, electrical and thermal adverse effect on the insulation that is stressed by bending.

If the extrusion apparatus is designed such that even already bent conductor bars can be coated using it, then the quasi-continuous extrusion methods described above can also advantageously be applied to already bent conductor bars. In this case, the bent conductor bars are provisionally connected in step a to form a quasi-infinite conductor with a number of bends, which is supplied in a suitable manner to the extrusion apparatus in this form. In addition to elastomers, more cost-effective thermoplastics may also advantageously be used for this method.

### BRIEF DESCRIPTION OF THE DRAWINGS

The invention will be explained in more detail in the following text with reference to exemplary embodiments and in conjunction with the drawings, in which:

FIG. 1 shows a quasi-infinite, straight conductor bar running through an extrusion apparatus;

FIG. 2 shows a quasi-infinite, bent conductor bar running through an extrusion apparatus;

FIG. 3 shows an insulated conductor bar, in which the provisional connection has been detached again;

FIG. 4 shows an apparatus for bending the insulated, straight conductor bars.

Only those elements and components which are essential for understanding the invention are shown in the figures. The illustrated methods and apparatuses according to the invention may thus be added to, or else modified in many ways in manners which are obvious to those skilled in the art without in the process departing from or changing the idea of the invention.

### APPROACHES TO IMPLEMENTATION OF THE INVENTION

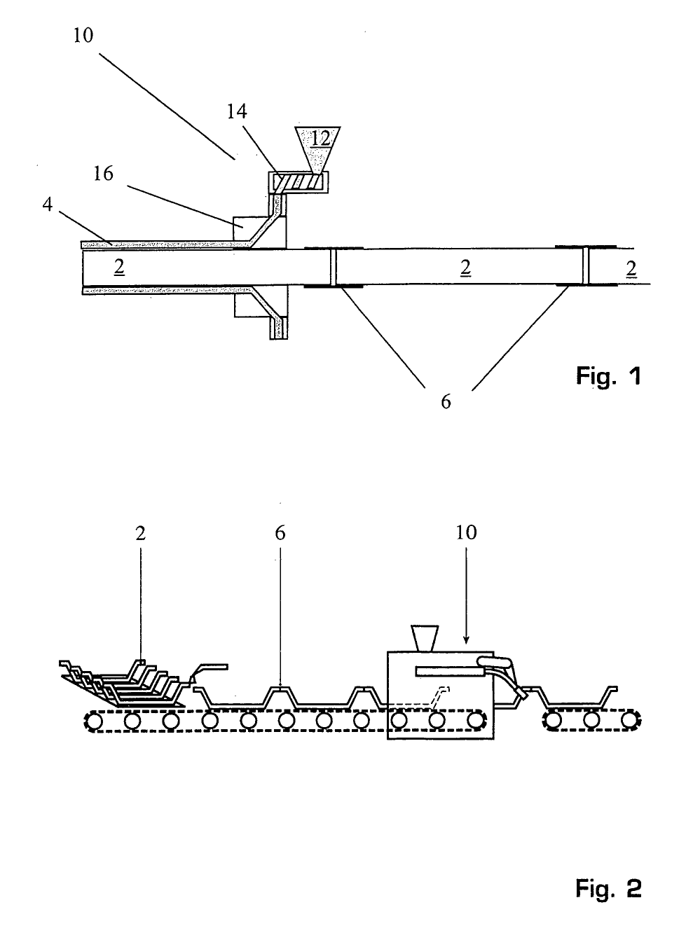

FIG. 1 shows an overview of a number of conductor bars 2 with a rectangular cross section, which are connected to one another by means of provisional connections 6. The provisional connection between the individual conductor bars is produced in FIG. 1 by using a thin-walled sleeve, which has in each case been drawn over the rear end of an n-th conductor bar and over the front end of an (n+1) conductor bar. The sleeve itself can be connected to the conductor bars by welding, soldering, clamping, screwing, adhesive bonding, etc. The sleeve is preferably stiff, in order to give the resultant connection a certain dimensional stability, in order that the quasi-infinite conductor bar can also be supplied continuously to the extruder 10. As an alternative to a sleeve, plates may be used, and these are attached only to two opposite surfaces of the end part of the rectangular conductor bar. A connection using plates can be produced more quickly but is not as robust as sleeve connections. The conductor bars may also be connected directly to one another on their end faces, for example by soldering, welding or adhesive bonding etc., without having to use any additional material for the provisional connection.

The conductor bars themselves are generally formed from a group of individual insulated conductors. In the case of transposed conductor bars, some of the individual conductors are twisted with one another, while in the case of non-transposed conductor bars, the individual conductors run parallel to one another, without any twisting. Conductor bars with individual conductors having a round cross section may be used in the invention. However, it is particularly advantageous to apply the method according to the invention to conductor bars with individual conductors having a rectangular cross section. When using rectangular cross sections, the advantages of the invention are achieved even when the cross sections of the individual conductors and/or of the conductor bar differ slightly from the rectangular shape. Pressing rollers are advantageously arranged upstream of the extruder for the coating process. These hold the individual conductors in the conductor bar closely together, in order to allow the conductor bar to be sheathed with the main insulation uniformly and without any cavities. Other possible ways to hold the individual conductors closely adjacent to one another are, for example, provisional adhesive bonding of the individual conductors with an elastic material or an adhesive which is mechanically weak with respect to shear forces, so that the subsequent bending is not impeded. Alternatively, it is also possible to use an adhesive which loses its adhesive force when heated to a reasonable extent (for example before bending), thus assisting the bending process.

In one preferred embodiment, the individual conductor bars run straight, so that the quasi-infinite conductor bar 8 which is formed by the provisional connections also runs straight. The straight profile of the quasi-infinite conductor bar allows, inter alia, easier supply to the extruder. FIG. 1 shows three individual conductor bars of the quasi-infinite conductor bar 8 that is formed. Although there is no intended upper limit to the number of individual conductor bars, the insulating process can be terminated, for manufacturing reasons, after a finite number of conductor bars, for example 50, 100, 1 000 or more. After leaving the extruder, the quasi-infinite conductor bar is provided with an insulating layer 4 of the desired thickness.

If the extrusion apparatus is appropriately designed such that it is also able to coat three-dimensionally bent conductor bars with insulation, then, in a further exemplary embodiment, the method of quasi-continuous extrusion can also be applied to conductor bars which have been bent in this way. For this purpose, the bent conductor bars are provisionally connected to one another in the same manner as the straight conductor bars, and are supplied in this way to the extruder 10 (FIG. 2). Since, in this exemplary embodiment, the evolvents of the conductor bars 2 are already bent before the coating process, no further bending process is required to complete the conductor bars. There is therefore scarcely any mechanical load on the insulating layer during the manufacturing process, so that thermoplastic may also be used as the material.

The material to be processed, the elastomer and, for bent conductor bars, the elastomer or the thermoplastic, is pressed in the extruder 10 as a molding compound out of a pressure chamber in the plasticized state via an appropriately profiled extruder tool through a nozzle continuously into free space. This results in a rectangular, endless length of flexible sleeve, which sheaths the quasi-infinite conductor bar. The raw material (for example in the form of a granulate, powder, or rubber mass) is supplied via the load 12 to the conversion area 14, in which it is compressed, preheated and converted to a plasticized molding compound. A worm is used, for example, for transportation within the conversion area 14. A shaping tool 16 carries out the subsequent shaping of the flexible material sleeve to the rectangular conductor cross section. It is possible to use not only an extruder head with a round cross section in the inlet area (with subsequent shaping), but also an extruder which has a rectangular cross section in the material inlet area itself. The material characteristics of the main insulation may be adjusted by addition of active (for example silicic acid) and passive (for example quartz sand) fillers, so that they satisfy the corresponding mechanical requirements for the electrical machines in which the stator windings provided with the main insulation are installed.

Silicone elastomer is particularly suitable for the material for the main insulation. A mechanically flexible thermoplastic may also be used as an alternative to this. A commercially available thermoplastic, which is not specifically mechanically flexible, may also be used in the example with bent conductor bars.

In some applications, the conductor bars are preferably provided with slot corona-discharge protection and this turning point (bracket corona-discharge protection) possibly as well as internal corona-discharge protection. The internal corona-discharge protection for a stator winding is generally a conductive material layer which is located between the main insulation and the conductor bar. This ensures a defined potential layer located around the conductor bar, and prevents electrical discharges which can be caused by cavities located between the conductor bar and the main insulation. The slot or external corona-discharge protection for a stator winding is generally a conductive material layer arranged between the main insulation and the stator slot. The external corona-discharge protection, which once again produces a defined potential layer, is intended to prevent electrical discharges which, for example, can be caused by different distances between the insulated conductor bar, which is at a high potential, and the stator slot, which is at ground potential. The turning point (bracket corona-discharge protection) generally prevents electrical discharges at the point at which a conductor bar leaves the slot. Possible ways for application of such protective layers which are used within the scope of the invention are, for example, conductive or semiconductive paints based on elastomers, appropriate strips (in some circumstances self-welding) which can be crosslinked by means of radiation or heat. Alternatively, cold-shrinking or heat-shrinking flexible sleeves (for example for bars) or collars (for example for coils) may be used. When shrink sleeves or collars are used for the internal corona-discharge protection, these may advantageously be provided on their inner face with a plastic material which can flow, in order to fill cavities located on the surface of the conductor bar. In principle, this is also possible for external corona-discharge protection.

In a further preferred refinement of the method, the insulation is fitted together with the slot corona-discharge protection and, if appropriate, with the internal corona-discharge protection by means of double or triple co-extrusion in one process. The slot corona-discharge protective layer is in this case preferably applied only in that area of the rod which will later be located in the slot. The bracket corona-discharge protection in order to prevent point discharges at the end of the slot corona-discharge protection can be applied by means of the already mentioned methods.

A further possible way to apply one or more material layers to the rectangular conductor bar is the blow forming technique. A flexible sleeve is first of all extruded, and is subsequently placed over the conductor. This technique is preferably used when applying a number of layers.

In one preferred embodiment, an elastomer is used as the material for the insulating layer 4. The elastomer is distinguished by high elasticity. Furthermore, it has good resistance to electrical and thermal loads. Silicone elastomers are preferably used, especially for thermally highly loaded machines. The use of elastomer (in contrast to other materials which may likewise be applied using an extrusion process) particularly satisfies the stringent requirements for resistance of the material, and for its mechanical flexibility. The elastomers which are used may be cold-crosslinking or heat-crosslinking types. Crosslinking in the case of cold-crosslinking types is started, for example, by mixing two components in the extruder, with one of the components containing a crosslinking agent. In the case of the heat-crosslinking type, the elastomer may be heated in the extruder itself, and/or after sheathing of the conductor bar. The latter is advantageously carried out by means of hot air (oven) or by means of resistive or inductive heating of the conductor bar.

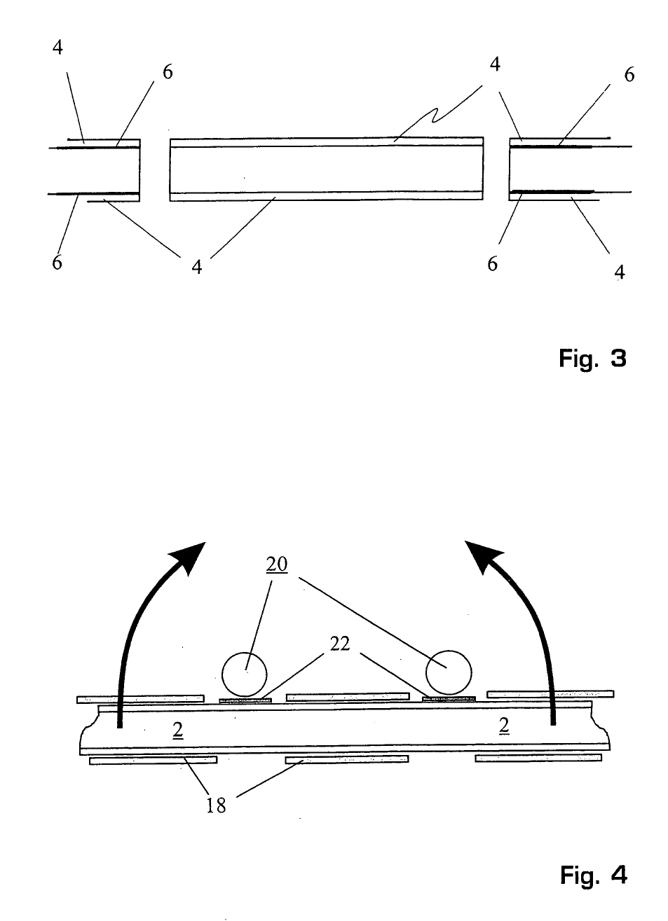

FIG. 3 shows the straight conductor bars 2, which have been provided with an insulating layer 4, after detachment of the provisional connection 6. When using stiff sleeves, the conductor bar is cut through directly at the front and rear end of the sleeve, so that only that part of the insulated conductor bar which is provided with the sleeve is produced as waste. Shorter sleeves naturally reduce the amount of waste. When choosing the sleeve length (or plate length), a compromise is reached between the strength of the connection and the length of the resultant waste pieces.

FIG. 4 shows a bending apparatus which has been modified from that in the prior art. The insulated, straight conductor bars are placed in the clamping jaws 18 of the bending apparatus, where they are changed to their final shape by movement of the clamping jaws 18 with respect to the bending tools 20. A protective layer 22 is arranged between the bending tools 20 and the insulating layer 4 on the conductor bar 2, thus distributing the pressure that is produced on the bending tools over its area, and thus preventing excessive. pinching of the insulating layer. The uniformly distributed mechanical load on the insulating layer composed of elastomer prevents damage to the insulating layer. The bending of the evolvent leads to a very large amount of stretching in the insulating layer, which would lead to fractures in the insulating layer if conventional materials such as high-temperature thermoplastics were used. Polyethylene has the necessary flexibility, but not the temperature resistance required for normal electrical machines, but could in principle be used in a similar manner for machines where the thermal load level is low (T<90° C.). The same applies to other, flexible thermoplastics.

If the conductor bar is formed from a group of individual conductors, then the bending of the conductor bars which have already been provided with the main insulation results in relative movement between the individual conductors and between those individual conductors that are located on the surface of the conductor bar and the main insulation. The boundary layer which is located between the conductor bar and the main insulation is advantageously designed such that it allows the individual conductors to move with respect to the main insulation with reduced friction. This can be achieved, for example, by treating the conductor bar with separating means. The occurrence of gaps as a result of this relative movement at the boundary surface to the conductor is not significant provided that internal corona-discharge protection, which is firmly connected to the main insulation, is used in this area. Without any internal corona-discharge protection, the movement is at most non-critical, since the field is reduced in the bending area (after the turning point).

When using internal corona-discharge protection, this advantageously has good adhesion to the main insulation but less adhesion to the surface of the conductor bar. This is preferably achieved by the insulation and corona-discharge protection being based on the same chemical material (chemical bonding), while the internal corona-discharge protection and the wire varnish are based on different materials, preferably with little affinity. This effect can be enhanced by separating means. The conductor bars themselves are preferably not transposed in the area of the subsequent bending points.

List of reference symbols

2 Conductor bar

4 Insulating layer

6 Provisional connection

8 Quasi-infinite conductor

10 Extruder

12 Loader

14 Conversion area

16 Shaping tool

18 Clamping jaws

20 Bending tool

22 Protective layer

1. A method for application of the main insulation to conductor bars, the conductor bars having a rectangular cross section, the method comprising:
a) connecting individual conductor bars to form a quasi-infinite conductor bar with a rectangular cross section;
b) continuously sheathing the quasi-infinite, rectangular conductor bar with main insulation; and
c) cutting out or detaching of unusable connecting points.

2. The method as claimed in claim 1, wherein, connecting comprises connecting conductor bars which extend in straight lines; and
sheathing comprises sheathing with an elastomer.

3. The method as claimed in claim 1, wherein sheathing comprises extrusion.

4. The method as claimed in claim 1, further comprising
d) bending an evolvent of the insulated conductor bars.

5. The method as claimed in claim 1, wherein connecting comprises connecting curved conductor bars; and sheathing comprises sheathing with a thermoplastic or an
elastomer.

6. The method as claimed in claim 1, wherein sheathing comprises blow forming.

7. The method as claimed in claim 1, wherein continuously sheathing further comprises fitting internal corona-discharge protection between the main insulation and the conductor surface, with adhesion between the internal corona-discharge protection and the main insulation being greater than adhesion between the internal corona-discharge protection and the conductor surface.

8. The method as claimed in claim 1, wherein continuously sheathing further comprises applying slot corona-discharge protection, turning point, or both.

9. The method as claimed in claim 1, wherein said conductor bars comprise conductor bars composed of individual.

10. The method as claimed in claim 9, wherein connecting comprises provisionally connecting the individual conductors to one another.

11. The method as claimed in claim 9, wherein the conductor bars are not transposed in the area of evoluting.

12. Insulated conductor bars formed by a process as claimed in claim 1.

13. A bending apparatus useful in applying main insulation conductor bars, the apparatus comprising:
bending tools; and
a protective layer arranged in the area of the bending tools.

14. A method as claimed in claim 1, wherein the conductor bars comprise conductor bars for stator windings.

15. A method as claimed in claim 2, wherein sheathing comprises sheathing with a silicone elastomer.

16. A method as claimed in claim 5, wherein sheathing comprises sheathing with a silicone elastomer.

17. A method as claimed in claim 9, wherein the individual conductors each have a rectangular cross section.

18. A method as claimed in claim 1, further comprising:
evoluting the conductor bars.
